(19) United States
(12) Patent Application Publication
(10) Pub. No.: US 2009/0063340 A1
(43) Pub. Date: Mar. 5, 2009

(54) Contact-less transaction card and the method of the same

(76) Inventor: Kuo-Ching Chiang, Linkou Township (TW)

Correspondence Address: BIRCH STEWART KOLASCH & BIRCH, PO BOX 747, FALLS CHURCH, VA, 22040-0747, US

(21) Appl. No.: 11/896,730

(22) Filed: Sep. 5, 2007

(51) Int. Cl. G06Q 40/00

(52) U.S. Cl. 705/41

(57) ABSTRACT

A contact-less transaction card includes a substrate, the substrate includes an IC coupled to a signal irradiation device to transmit and receive signal for transaction. The IC includes identify information of the individual.

### FIELD OF THE INVENTION

The present invention relates to an IC transaction card, especially, to a contact-less transaction card and the method of the same.

In general, the transaction or credit cards are popular in the field of transaction. The card is approximately 84 mm×54 mm in size. The card is typically used for financial, such as credit card, cash card. The operator aligns the magnetic strip to the slot of the contact card reader during transaction. However, the security of such transaction is not safe and the card will be damage frequently. Additionally, the password or security information is likely to be monitor by others.

### SUMMARY

The present invention discloses a method of contact-less transaction comprising: implanting a contact-less card including transaction card, credit card or cash card into the mobile terminal; wherein said contact-less card includes a transmitter or coupled to a transmitter; contact-lessly attaching said mobile terminal to a contact-less card reader by transmit the transaction signal from said transmitter for processing contact-less transaction.

The contact-less card is an independent card to a SIM card or is integrated with said SIM card. The transmitter is an antennal or coils set within said contact-less card, within said SIM card, within internal of said mobile terminal or outside of said mobile terminal to avoid the EM shielding effect. The method further comprises displaying the transaction information on the display of said mobile terminal and/or downloading the transaction information through said mobile terminal.

A method of contact-less transaction is disclosed the method comprises implanting a contact-less card including transaction card, credit card or cash card into the mobile terminal; wherein said mobile terminal includes wireless data exchanging module and said contact-less card includes a transmitter or coupled to a transmitter; contact-lessly attaching said mobile terminal to a contact-less card reader by transmit the transaction signal from said transmitter for processing contact-less transaction; downloading transaction information through said wireless data exchanging module. The contact-less card is an independent card to a SIM card or is integrated with said SIM card. The transmitter is an antennal or coils set within said contact-less card, within said SIM card, within internal of said mobile terminal or outside of said mobile terminal to avoid the EM shielding effect. The method further comprises displaying the transaction information on the display of said mobile terminal. The wireless data exchanging module is RF module or WiFi module.

A method of contact-less transaction comprises: implanting a contact-less card including transaction card, credit card or cash card into the mobile terminal having a SIM for identifying the subscriber of said mobile terminal; wherein said contact-less card includes a transmitter or coupled to a transmitter; contact-lessly attaching said mobile terminal to a contact-less card reader by transmit the transaction signal from said transmitter for processing contact-less transaction; wherein said contact-less card is coupled to said SIM in order to identify the transaction. The SIM includes interface, wherein said contact-less card is coupled to said interface. The transmitter is an antennal or coils set within said contact-less card, within said SIM card, within internal of said mobile terminal or outside of said mobile terminal to avoid the EM shielding effect. The method further comprises displaying the transaction information on the display of said mobile terminal and/or downloading the transaction information through said mobile terminal.

The present invention discloses a contact-less transaction method, it includes steps of providing a contact-less credit card and contact-less card reader, wherein said contact-less credit card and contact-less card reader includes a signal transmitter, respectively. The method includes step of contact-less attaching the credit card to the card reader for transmitting signals wirelessly, wherein the contact-less credit card includes IC coupled to the transmitter. It may store or record the user information or transaction information.

The present invention discloses a contact-less financial transaction method, it includes steps of providing a contact-less transaction card and contact-less ATM, wherein said contact-less transaction card and contact-less ATM includes a signal transmitter, respectively. The method includes step of wirelessly attaching the transaction card to the ATM for transmitting signals wirelessly to process the transfer, depositing or drawing via the contact-less transaction, wherein the contact-less transaction card includes IC coupled to the transmitter (such as antenna or coils). It may store or record the user information, bank information, password, account information or transaction information.

The IC or memory of the card may store the card number, effect date, user information. The antenna could be planer antenna, PIFA, fractal antenna, coils and so on

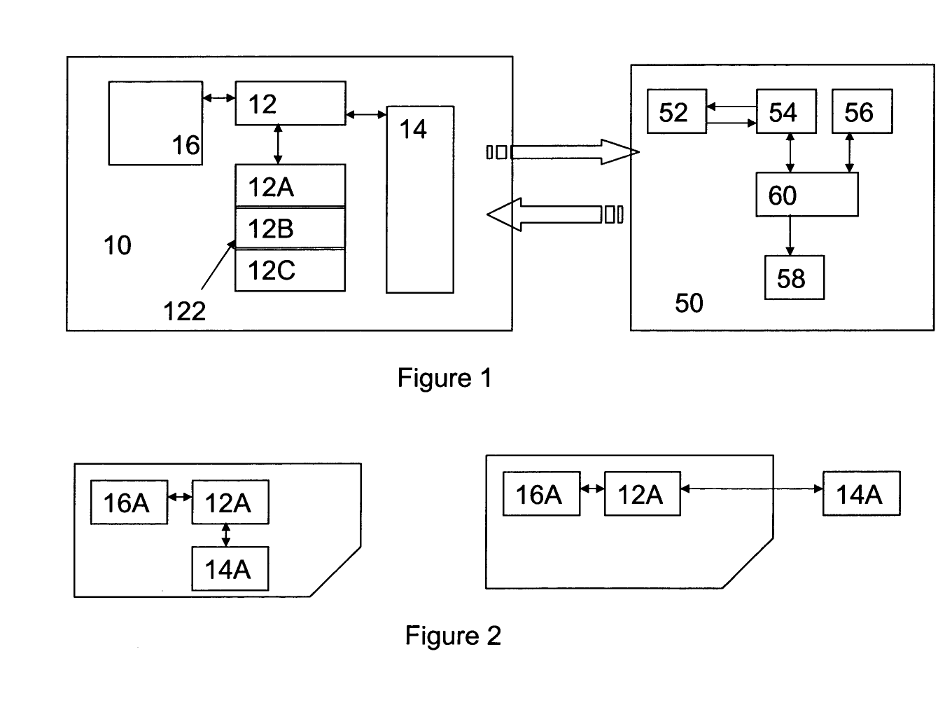

FIG. 1 describes a contact-less IC card of the present invention.

FIG. 2 illustrates contact-less SIM card of the present invention.

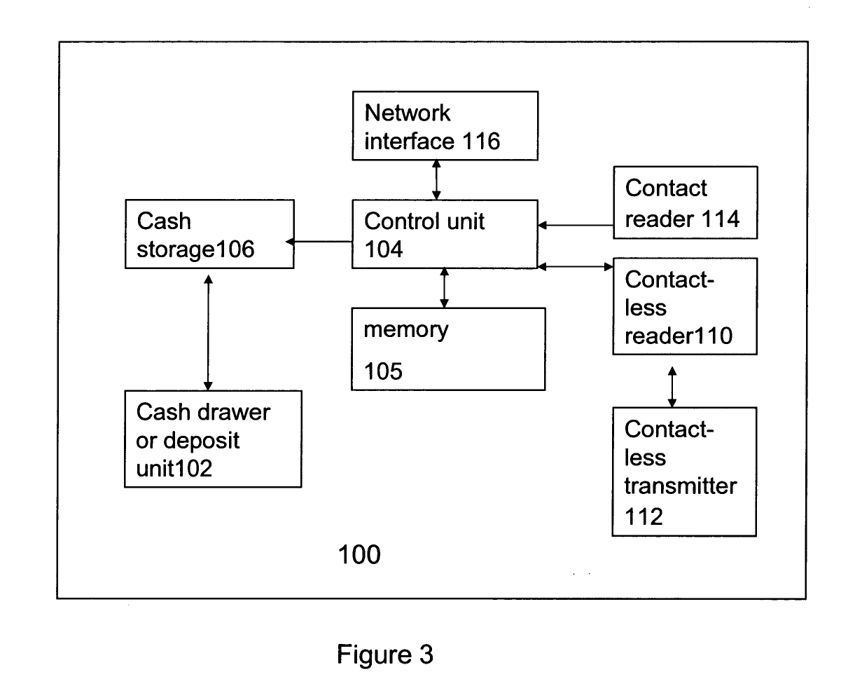

FIG. 3 illustrates the ATM according to the present invention.

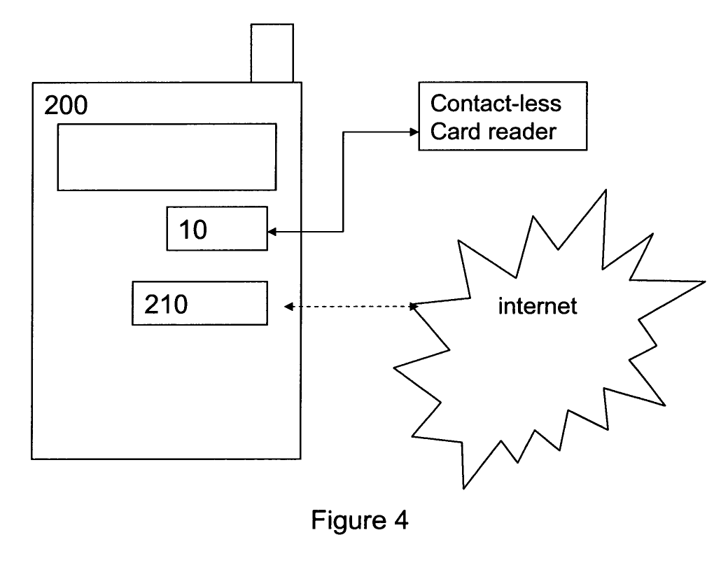

FIG. 4 illustrates the mobile phone with the contact-less card according to the present invention.

### DETAILED OF THE PRESENT INVENTION

The present invention is adaptable to credit card transaction, financial transaction, such as automated teller machine, card reader, point of sales and personal identify.

Turning to FIG. 1, it illustrates an IC card 10 including substrate 12 formed of such as plastic material. For example, the thickness of the substrate is about 0.08 mm to 0.12 mm. Preferably, the card is dimensioned as the size of the current transaction card. The magnetic strip is optional for the embodiment.

As shown in the illustration, the IC card includes IC 12 coupled to an antenna (or resonant coils) 14. The antenna 14 is located at any where of the card. For credit card, the user information, code, card numbers are stored into the IC or memory. The IC could be a single chip, integrated chip or multiple chips. The substrate could be flexible material, transparent or non-transparent material. The IC could includes memory such as FLASH memory etc. in order to store information.

For example, the IC 12 may couple to memory 122 for transaction identify. The information includes but not limited to card number 12A, effective date 12B and user information or code. The IC 12 can be integrated with the memory 122. The transmitter could be an antenna or resonant coils. The credit card may remove the magnetic strip or metal interface such as the pins on the card.

The IC card 10 may omit the interface 16 and transmit information by wirelessly. The card reader may communicate with the card with/or without the interface 16. It could be applied to the point of sales (POS), ATM. The IC card could be credit card, finical card, cash card. The present invention includes planar antenna. The antenna could be replace by coils and located on the any suitable location on the substrate.

Compare to the prior art, the user may omit to provide the password for the transaction, financial service such as ATM service. The transaction may secure the personal information, password not to be monitored by others due to the wireless transaction. It is because that the card is not held by the operator, therefore, it may keep the card clean and safe. Additionally, the information may be not labeled on the surface of the substrate. The others can fetch nothing from the card. The digital signature may be stored in the memory 122 in order to identify the transaction. The surface pattern may be customized by the user and the memory 122 may store the digital personal photo for security identification.

Alternatively, the present invention may be incorporated into the SIM for the portable phone as shown in the FIG. 2. A card 10A with the antenna 14A is attached internal or external of the portable device. The card includes I/O interface 16A coupled to the phone. The antennal 14A is a near field transaction antenna rather than the RF antenna of the phone. Therefore, the phone can be used as the transaction tool. Based on the features, the SIM may identify the user of the phone, it can be used as the code to identify the one who deals with the transaction. Therefore, users may use the phone embedded with the contactless card as the transaction tool for near field transaction. It may through the service party for example, communication service company, credit card center or bank to charge the transaction. Otherwise, it may download the credit points from the communication network or internet, the card acts as the payment tool or cash card. The aforesaid interface 16A of the SIM includes eight pins for connection. The mobile phone may use six of them, it leaves two pins. Therefore, the two pins may be used to couple to the antenna for contactless transaction, thereby connecting with the IC 12A. Based on the improvement of the IC technology, it allows enough capacity to store the credit points or electronic money. The related information may be displayed and processed by the software in the phone 200 or IC, therefore, the transaction record or information could be stored or displayed. The user may added the credit value into the card through POS system or download the coupon through the communication network or internet if the phone having the wireless module such as WiFi 210, as shown in FIG. 4. It may automatically add the electronic cash value when the electronic money below the threshold.

During operation, the contact-less reader or POS may be supplied by power and generate magnetic field or electronic current to drive the IC for fetching the information stored in the memory. Similarly, the card may receive the signal from the reader by electronic-magnetic effect. The coils 52 of the contactless reader 50 may transmit or receive signal to read/write device 54. A control unit 60 coupled to the read/write device to process the received or delivered signal. The coils maybe replaced by antenna. The contactless card reader or POS maybe connected to the terminal server and coupled to the control unit 60 through the internet interface 56 for interchanging the information with the database. A printing unit 58 is coupled to the control unit 60 in order to print the transaction receipt.

FIG. 3 illustrates the contact-less ATM 100 including cash drawing unit and/or depositing unit 102 for drawing or depositing money. A control unit 104 is provided to control the input signal and coupled to the main frame (not shown) for transaction identification and data query. A memory 105 may couple to the control unit 104. A cash storage is used to store cash and coupled to the cash drawing unit and/or depositing unit 102 through cash delivery 108. The contact-less ATM includes a contact-less read-writer 110 coupled to the contact-less signal transmitter 112 and the control unit 104 for near field wireless transaction. The ATM will couple to the terminal for identification while transaction. It may also include the contact reader 114 for conventional usage. It may couple to the terminal database for information exchange.

Based on the above illustration, the present invention may be used as the member or personal identification card. The data stored in the memory includes member information (member number, social security information), digital photo, security information, record, blood type, health information, address etc.

The present invention disclosed a transaction method through mobile terminal such as mobile phone, mobile PDA. The method includes the step of implanting a contact-less transaction card, credit card or cash card into the mobile phone. The contact-less card includes a transmitter or the contact-less card is coupled to a transmitter. The user may transact with other party by attaching the mobile terminal (phone) to the contact-less card reader by transmit the transaction signal from the antenna of the contact-less card. The contact-less card is an independent card to the SIM card or it could be integrated with the SIM card. In one case, the antennal or the coils is set within the card, within the SIM card, within the internal of the phone or outside of the phone to avoid the EM shielding effect.

The present invention discloses a contact-less transaction method, it includes steps of providing a contact-less credit card and contact-less card reader, wherein said contact-less credit card and contact-less card reader includes a signal transmitter, respectively. The method includes step of contact-less attaching the credit card to the card reader for transmitting signals wirelessly, wherein the contact-less credit card includes IC coupled to the transmitter. It may store or record the user information or transaction information.

The present invention discloses a contact-less financial transaction method, it includes steps of providing a contact-less transaction card and contact-less ATM, wherein said contact-less transaction card and contact-less ATM includes a signal transmitter, respectively. The method includes step of wirelessly attaching the transaction card to the ATM for transmitting signals wirelessly to process the transfer, depositing or drawing via the contact-less transaction, wherein the contact-less transaction card includes IC coupled to the transmitter (such as antenna or coils). It may store or record the user information, bank information, password, account information or transaction information.

The material for the antenna includes oxide containing metal, wherein the metal can be selected one or more from Au, Ag, Pt, In, Ga, Al, Sn, Ge, Sb, Bi, Zn, and Pd. Some conductive materials formed by the method are transparent, if the antenna is attached on the glass or panel of the device, one may see through the panel, glass. Alternately, the antenna could be formed on the cover, screen of the notebook, cell phone and so on. In this case, the conductive layer, usually composed by a material includes oxide containing metal or alloy, wherein the metal is preferable to select one or more metals from Au, Zn, Ag, Pd, Pt, Rh, Ru, Cu, Fe, Ni, Co, Sn, Ti, In, Al, Ta, Ga, Ge and Sb. Some of the transparent material includes oxide containing Zn with Al2O3 doped therein. This shape is constructed by using an adequate mask during the forming process of the transparent conducting layer. In the case, the inner coaxial cable is directly connected to the element of the conductive layer, which can be optionally connected to the metallic body of the car. Other feeding configurations are possible such as by using a capacitive coupling. The feeding mechanism is well known in the art. The reception system can be improved by using space-diversity or polarization diversity techniques. Two or several multi-band antennas or an antenna array can be used. The advantage of using the techniques described in the present invention is that attaching a plurality of antennas in the same transparent substrate such that the diversity scheme can be included at a low cost. The feeding scheme is well known by those skilled in the art, other configurations of multi-band antennas can be used as well within the same scope and spirit of the present invention. The polygon-based structure can be chosen as an alternative shapes whenever polarization diversity schemes are to be introduced to compensate the signal fading due to a rapidly changing propagation environment.

The method for forming the transparent conductive layer includes ion beam method for film formation at low temperature, for example, the film can be formed with receptivity lower than 3×10−4 Ω.cm at room temperature. Further, the RF magnetron sputtered thin film method could also be used. The transparent can be higher than 82%. It is well known in the field of forming thin film. Under the cost and production consideration, the method for forming the antenna film, for example, indium tin oxide, could be formed at room temperature in wet atmosphere has an amorphous state, a desired pattern can be obtained at a high etching rate. After the film is formed and patterned, it is thermally treated at a temperature of about between 180 degree C. and 220 degree C. for about one hour to three hours to lower the film resistance and enhance its transmittance. Another formation is chemical solution coating method. The coating solution includes particles having an average particle diameter of 1 to 25 μm, silica particles having an average particle diameter of 1 to 25 μm, and a solvent. The weight ratio of the silica particles to the conductive particles is preferably in the range of 0.1 to 1. The conductive particles are preferably metallic particles of one or more metals selected from Au, Zn, Ag, Pd, Pt, Rh, Ru, Cu, Fe, Ni, Co, Sn, Ti, In, Al, Ta, Ga, Ge and Sb. The conductive particles can be obtained by reducing a salt of one or more kinds of the aforesaid metals in an alcohol/water mixed solvent. Heat treatment is performed at a temperature of higher than about 100 degree C. The silica particles may improve the conductivity of the resulting conductive film. The metallic particles are approximately contained in amounts of 0.1 to 5% by weight in the conductive film coating liquid.

The transparent conductive film can be formed by applying the liquid on a substrate, drying it to form a transparent conductive particle layer, then applying the coating liquid for forming a transparent film onto the fine particle layer to form a transparent film on the particle layer. The coating liquid for forming a transparent conductive layer is applied onto a substrate by a method of dipping, spinning, spraying, roll coating, flexographic printing or the like and then drying the liquid at a temperature of room temperature to about 90 degree. C. After drying, the coating film is curing by heated at a temperature of not lower than 100 degree C. or irradiated with an electromagnetic wave or in the gas atmosphere.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

1. A method of contact-less transaction comprising: implanting a contact-less card including transaction card, credit card or cash card into the mobile terminal; wherein said contact-less card includes a transmitter or coupled to a transmitter; contact-lessly attaching said mobile terminal to a contact-less card reader by transmit the transaction signal from said transmitter for processing contact-less transaction.

2. The method of claim 1, wherein said contact-less card is an independent card to a SIM card or is integrated with said SIM card.

3. The method of claim 2, wherein said transmitter is an antennal or coils set within said contact-less card, within said SIM card, within internal of said mobile terminal or outside of said mobile terminal to avoid the EM shielding effect.

4. The method of claim 1, further comprising displaying the transaction information on the display of said mobile terminal.

5. The method of claim 1, further comprising downloading the transaction information through said mobile terminal.

6. A method of contact-less transaction comprising: implanting a contact-less card including transaction card, credit card or cash card into the mobile terminal; wherein said mobile terminal includes wireless data exchanging module and said contact-less card includes a transmitter or coupled to a transmitter; contact-lessly attaching said mobile terminal to a contact-less card reader by transmit the transaction signal from said transmitter for processing contact-less transaction; downloading transaction information through said wireless data exchanging module.

7. The method of claim 6, wherein said contact-less card is an independent card to a SIM card or is integrated with said SIM card.

8. The method of claim 7, wherein said transmitter is an antennal or coils set within said contact-less card, within said SIM card, within internal of said mobile terminal or outside of said mobile terminal to avoid the EM shielding effect.

9. The method of claim 6, further comprising displaying the transaction information on the display of said mobile terminal.

10. The method of claim 6, wherein said wireless data exchanging module is RF module or WiFi module.

11. A method of contact-less transaction comprising: implanting a contact-less card including transaction card, credit card or cash card into the mobile terminal having a SIM for identifying the subscriber of said mobile terminal; wherein said contact-less card includes a transmitter or coupled to a transmitter; contact-lessly attaching said mobile terminal to a contact-less card reader by transmit the transaction signal from said transmitter for processing contact-less transaction; wherein said contact-less card is coupled to said SIM in order to identify the transaction.

12. The method of claim 11, wherein said SIM includes interface, wherein said contact-less card is coupled to said interface.

13. The method of claim 11, wherein said transmitter is an antennal or coils set within said contact-less card, within said SIM card, within internal of said mobile terminal or outside of said mobile terminal to avoid the EM shielding effect.

14. The method of claim 11, further comprising displaying the transaction information on the display of said mobile terminal.

15. The method of claim 11, further comprising downloading the transaction information through said mobile terminal.
